(19) United States
(12) Patent Application Publication
(10) Pub. No.: US 2007/0289609 A1
(43) Pub. Date: Dec. 20, 2007

(54) METHOD FOR CLEANING A PROCESS CHAMBER

(75) Inventors: Hyun-Seok LIM, Gyeonggi-do (KR); Gyu-Hwan OH, Gyeonggi-do (KR); Rak-Hwan KIM, Gyeonggi-do (KR); Keon-Hoe BAE, Seoul (KR); In-Sun PARK, Gyeonggi-do (KR); Ki-Jong LEE, Gyeonggi-do (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-do (KR)

(21) Appl. No.: 11/765,356

(22) Filed: Jun. 19, 2007

(30) Foreign Application Priority Data
Jun. 19, 2006 (KR) 2006-55062

(51) Int. Cl. B08B 9/00; B08B 3/00

(52) U.S. Cl. 134/22.1; 134/26

(57) ABSTRACT

According to an embodiment of the present invention, a method for cleaning a process chamber includes removing a TiAlN layer from an inner wall of the process chamber using a first cleaning gas containing a TiCl₄ gas. According to principles of this invention, dry cleaning, without wet cleaning, is possible for cleaning the process chamber.

### CROSS-REFERENCE TO RELATED APPLICATIONS

This U.S. non-provisional patent application claims priority under 35 U.S.C. §119 of Korean Patent Application No. 2006-55062, filed on Jun. 19, 2006, the entire contents of which are hereby incorporated by reference.

### BACKGROUND OF THE INVENTION

The present invention disclosed herein relates to a method for cleaning thin film deposition equipment for manufacturing a semiconductor device.

Semiconductor device manufacturing processes include deposition of various material layers onto a substrate, including subsequent patterning of the deposited layers. The deposition of the material layers are deposited within the isolation provided by a process chamber so that influences of the outside atmosphere can be eliminated. The deposition may be classified into chemical vapor deposition (CVD) and physical vapor deposition (PVD).

In most deposition technologies, material layers are not only formed on the semiconductor substrate as intended, but inner walls and surfaces of the process chamber may also be coated with the material layers. Any or all of these undesirably deposited material layers may become sources of particles that lead to defects in the resulting semiconductor device. Therefore, a cleaning process should be periodically performed for removing the unwanted material layers from the inner walls and surfaces of the process chamber.

The process chamber cleaning may be classified into a dry or wet type. The type of cleaning used depends on the properties of the material layer to be removed. Dry cleaning generally includes an operation of supplying a cleaning gas into the process chamber and an operation of exhausting a reaction gas that is produced by the reaction between the cleaning gas and the material layer, out of the process chamber. Since the dry cleaning is different from the deposition mainly in terms of the kind of gas supplied into the process chamber, the dry cleaning of the process chamber may be performed right after the deposition of the material layer without complicated preparation.

However, some materials used for manufacturing semiconductor devices are not suitable for dry cleaning the process chamber. For example, a TiAlN layer, which is mainly used for a lower electrode of a phase change random access memory (PRAM) or a diffusion barrier layer, is usually removed with a ClF3 gas. But in this case, AlF3 is in a solid state, which is difficult to exhaust from the process chamber. AlF3 is produced from a reaction between TiAlN and ClF3, as represented by the following chemical equation (1).

TiAlN(s)+ClF₃(g) AlF₃(s)+0.75TiN(s)+0.25TiCl₄(g)+0.125N₂(g) (1)

Accordingly, a deposition system involving a TiAlN layer needs to be cleaned by wet cleaning to remove the solid-state AlF3 layer from the process chamber.

FIG. 1 is a flowchart for illustrating a conventional method for cleaning a TiAlN deposition chamber.

Referring to FIG. 1, in operation S10, a semiconductor wafer is loaded into a process chamber. Then a process gas is supplied into the process chamber to form a TiAlN layer on the semiconductor wafer in operation S20. In operation S30, the semiconductor wafer including the TiAlN layer is unloaded from the process chamber to perform subsequent processes.

According to the conventional method, after the depositing operation S20 of the TiAlN layer is repeated n-times, a cleaning operation S40 is performed for removing the TiAlN layer from an inner wall and surfaces of the process chamber. The conventional cleaning operation S40 includes a step S41 of disassembling the process chamber, a step S42 of removing the TiAlN layer from the disassembled process chamber using a cleaning solution, and a step S43 of reassembling the cleaned process chamber.

Unfortunately, disassembling and reassembling the process chamber lead to its reduced life expectancy. In addition, the deposition system is interrupted for the conventional cleaning operation S40, greatly decreasing the productivity of the deposition system.

### SUMMARY OF THE INVENTION

The present invention provides a method for cleaning a process chamber having a TiAlN deposition using dry cleaning.

Embodiments of the present invention provide methods for cleaning a process chamber including dry cleaning a process chamber having a TiAlN layer using a cleaning gas containing TiCl₄. The method includes: loading a semiconductor wafer into a process chamber; forming a TiAlN layer on the semiconductor wafer; unloading the semiconductor wafer including the TiAlN layer from the process chamber; and supplying a first cleaning gas containing a TiCl₄ gas into the process chamber to remove the TiAlN layer formed on an inner wall of the process chamber.

In some embodiments, forming the TiAlN layer includes supplying TiCl₄, tetra-methyl-aluminum (TMA), and ammonia (NH₃) into the process chamber.

In other embodiments, removing the TiAlN layer includes exhausting an AlCl₃ gas generated by the reaction of the TiCl₄ gas contained in the first cleaning gas and the TiAlN layer out of the process chamber. Removing the TiAlN layer may include supplying the TiCl₄ gas with a flow rate of 1 sccm to 10 slm for 10 seconds to 10 minutes. The temperature and pressure inside the process chamber may range from 400° C. to 550° C. and 0.1 torr to 100 torr, respectively.

In still other embodiments, the first cleaning gas used during the removing of the TiAlN layer further includes an ammonia (NH₃) gas. In this case, the TiAlN layer formed on the inner wall of the process chamber reacts with the TiCl₄ gas and the ammonia (NH₃) gas to be decomposed into AlCl₃, hydrogen (H₂), TiCl₄, and hydrogen chloride (HCl) all in a gas state, which are exhausted out of the process chamber, and a TiN layer of solid state that is attached to the inner wall of the process chamber.

In other embodiments, removing the TiAlN layer includes: exhausting AlCl₃, hydrogen (H₂), TiCl₄, and hydrogen chloride (HCl) in a gas state generated by the reaction of the first cleaning gas and the TiAlN layer out of the process chamber; and supplying a second cleaning gas containing chlorine into the process chamber to remove the TiN layer attached to the inner wall of the process chamber. In this case, the second cleaning gas may be any one of a ClF₃ gas and a Cl₂ gas.

In yet other embodiments, when the second cleaning gas is the ClF₃ gas, the TiN layer attached to the inner wall of the process chamber reacts with the ClF₃ gas to be decomposed into TiF₄, ClF, F₂, and N₂, all in gas states, which are exhausted out of the process chamber.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a flowchart illustrating a conventional method for forming a TiAlN layer on a semiconductor wafer and a subsequent cleaning of the process chamber used in the method;

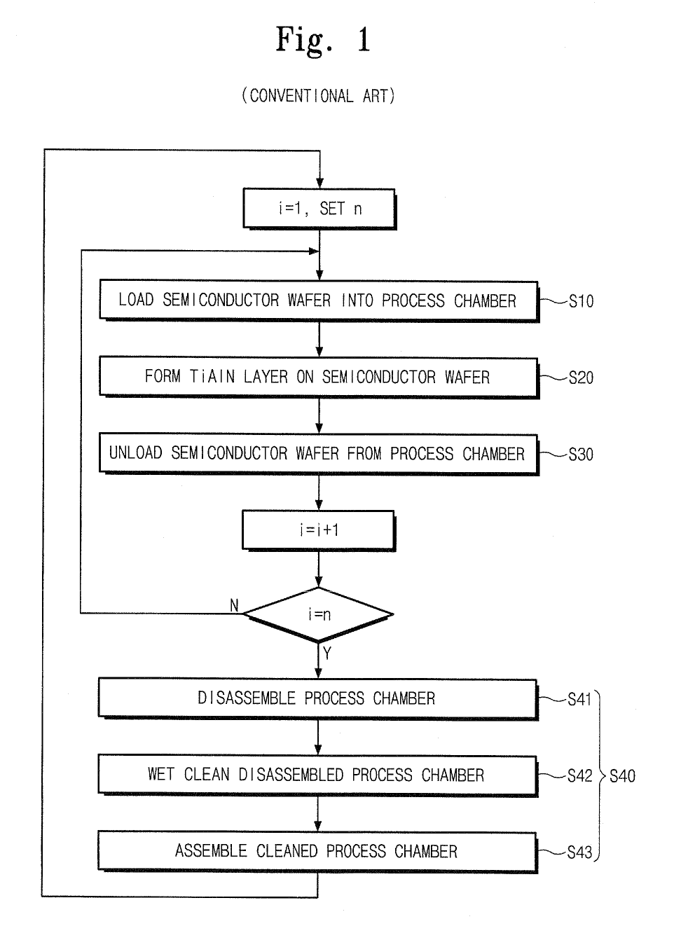

FIG. 2 is a flowchart illustrating a method for forming a TiAlN layer on a semiconductor wafer and a subsequent cleaning of the process chamber used in the method, according to an embodiment of the present invention; and

FIG. 3 is a flowchart for illustrating a method for forming a TiAlN layer on a semiconductor wafer and a subsequent cleaning of the process chamber used in the method, according to another embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as being limited to the embodiments set forth herein. Rather, these embodiments are provided so that this disclosure will be thorough and complete, and will fully convey the scope of the present invention to those skilled in the art.

In the specification, the dimensions of layers and regions are exaggerated for clarity of illustration. It will also be understood that when a layer (or film) is referred to as being ‘on’ another layer or substrate, it can be directly on the other layer or substrate, or intervening layers may also be present. Also, though terms like a first, a second, and a third are used to describe various regions and layers in various embodiments of the present invention, the regions and the layers are not limited to these terms. These terms are used only to tell one region or layer from another region or layer. For example, a layer referred to as a first layer in one embodiment can be referred to as a second layer in another embodiment.

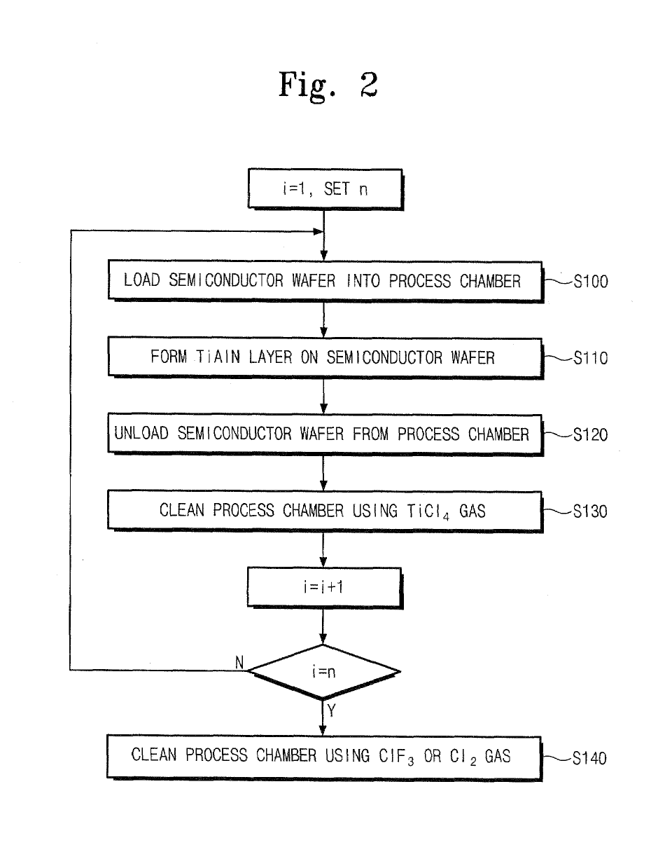

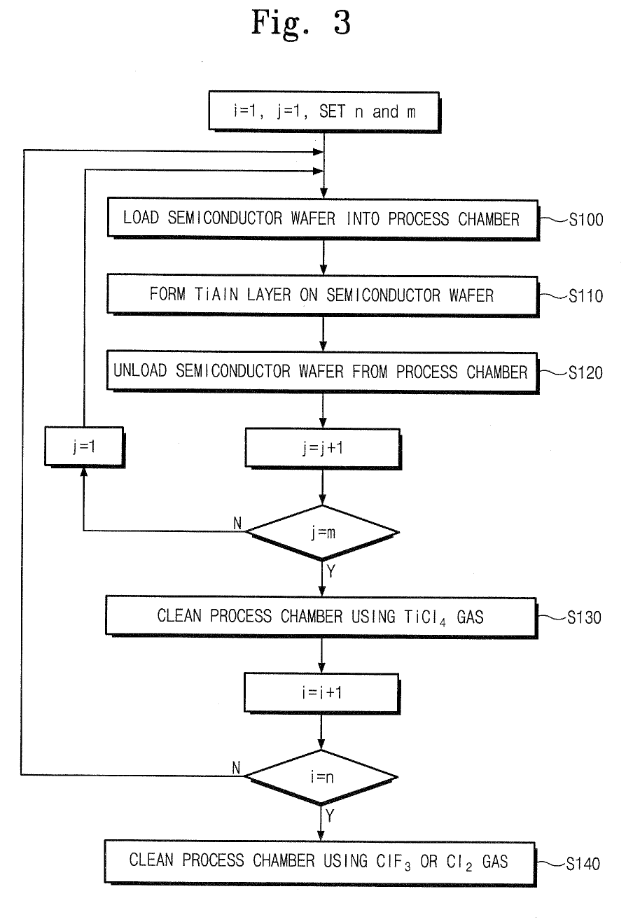

FIGS. 2 and 3 are flowcharts illustrating a method for forming a TiAlN layer on a semiconductor wafer and a subsequent cleaning of the process chamber used in the method, according to embodiments of the present invention.

Referring to FIG. 2, in operation S100, a semiconductor wafer is loaded into a process chamber. Then a process gas is supplied into the process chamber to form a TiAlN layer on the semiconductor wafer, as in operation S110. According to the present embodiment, forming the TiAlN layer may include supplying TiCl₄, tetra-methyl-aluminum (TMA), and ammonia (NH₃) as process gases into the process chamber, which may be heated to approximately 450-500° C.

Next, in operation S120 the semiconductor wafer including the TiAlN layer is unloaded from the process chamber. As described earlier, the TiAlN layer, which is generated by the reaction of the process gases, may also be formed on inner walls and surfaces of the process chamber. To remove the TiAlN layer formed on the inner walls and surfaces of the process chamber, a first cleaning operation S130 is performed, which supplies a first cleaning gas into the process chamber.

According to the present embodiment, the first cleaning gas contains TiCl₄. The TiCl₄ reacts with the TiAlN layer formed on the inner walls and surfaces of the process chamber to generate AlCl₃ gas that can be easily exhausted out of the process chamber.

In detail, during the first cleaning operation S130, the TiCl₄ gas may be supplied into the process chamber with a flow rate of between about 1 sccm to 10 slm for between about 10 sec to 10 min, and preferably with a flow rate of between approximately 20 sccm to 1 slm for between about 20-30 seconds. Also, during the first cleaning operation S130, the temperature and pressure inside the process chamber may range from approximately 20° C. to 600° C. and from about 0.1 torr to 100 torr, respectively, and preferably at a temperature between around 400-550° C. and the pressure of between approximately 1-5 torr.

In addition to the TiCl₄ gas, the first cleaning gas may further contain ammonia (NH₃) gas. The TiCl₄ and ammonia (NH₃) gas react with the TiAlN layer formed on the inner walls and surfaces of the process chamber to generate AlC₃, hydrogen (H₂), hydrogen chloride (HCl), and TiCl₄ that are in a gas state, as well as a TiN layer in a solid state, as represented by chemical equation (2) below.

TiAlN(s)+2TiCl₄(g)+NH₃(g) 0.99AlCl₃(g)+1.98TiN(s)+1.03H₂(g)+1.02TiCl₄(g)+0.94HCl(g) (2)

Here, since the AlCl₃, the hydrogen (H₂), the hydrogen chloride (HCl), and the TiCl₄ are in a gas state, they can be easily exhausted out of the process chamber. On the other hand, since the TiN layer is in a solid state, it remains on the inner walls and surfaces of the process chamber. However, the TiN layer has little possibility of leading to a defective semiconductor device, when compared with the TiAlN layer. In addition, according to the present embodiment, the TiN layer can be easily removed using a second cleaning gas in a second cleaning operation S140. Consequently, the TiAlN layer can be removed from the process chamber through the dry cleaning operations without wet cleaning.

In detail, the second cleaning operation S140 includes a removing operation of the TiN layer formed on the inner wall of the process chamber using the second cleaning gas containing chlorine. According to the present embodiment, the second cleaning gas may be ClF₃ gas or Cl₂ gas. When the ClF₃ gas is used as the second cleaning gas, the ClF₃ reacts with the TiN layer to generate TiF₄, ClF, F₂, and N₂, each in a gas state, as represented by chemical equation (3) below. Therefore, the TiN layer can be easily removed from the process chamber using the ClF₃ gas.

TiN(s)+4ClF₃(g) TiF₄(g)+4ClF(g)+4F₂(g)+1/2N₂(g) (3)

According to this embodiment, the first cleaning operation S130 may be repeated for n number of processes, and then the second cleaning operation S140 may be performed to improve the productivity of the deposition system. In this embodiment n is preferably an integer selected from the range of between 1 to 10000.

According to another embodiment, referring to FIG. 3, the first cleaning operation S130 may be performed after repeating the depositing operation S110 of the TiAlN layer m times, where m is preferably an integer selected from the range of 1 to 1000 to improve the productivity of the deposition system. The first cleaning operation S130 can be repeated for n processes before a second cleaning process S140 is performed.

According to the present embodiment, a process chamber for deposition of TiAlN is cleaned using a TiCl₄ gas. Accordingly, a TiAlN layer formed on inner walls and surfaces of the process chamber can be removed without wet cleaning. That is, the TiAlN layer formed on the inner wall of the process chamber can be removed with only dry cleaning operations. Consequently, there is no need to disassemble/assemble the process chamber, unlike a conventional cleaning method requiring the wet cleaning. In this respect, the cleaning method of the present invention can minimize problems of the conventional cleaning method, such as the reduction of the productivity and life of the system.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method for cleaning a process chamber, comprising:
loading a semiconductor wafer into a process chamber;
forming a TiAlN layer on the semiconductor wafer;
unloading the semiconductor wafer including the TiAlN layer from the process chamber; and
supplying a first cleaning gas including TiCl₄ into the process chamber to remove the TiAlN layer formed on the process chamber.

2. The method of claim 1, wherein forming the TiAlN layer comprises supplying TiCl₄, tetra-methyl-aluminum (TMA), and ammonia (NH₃) into the process chamber.

3. The method of claim 1, wherein removing the TiAlN layer comprises exhausting an AlCl₃ gas generated by the reaction of the TiCl₄ gas contained in the first cleaning gas and the TiAlN layer out of the process chamber.

4. The method of claim 1, wherein the first cleaning gas further comprises an ammonia (NH₃) gas.

5. The method of claim 4, wherein removing the TiAlN layer comprises reacting the TiAlN layer formed on the process chamber with the TiCl₄ gas and the ammonia (NH₃) gas to form AlCl₃ gas, hydrogen (H₂) gas, TiCl₄ gas, and hydrogen chloride (HCl) gas, and a TiN layer in a solid state.

6. The method of claim 4, wherein removing the TiAlN layer comprises:
exhausting AlCl₃ gas, hydrogen (H₂) gas, TiCl₄ gas, and hydrogen chloride (HCl) gas, which are generated by the reaction of the first cleaning gas and the TiAlN layer, out of the process chamber; and
supplying a second cleaning gas containing chlorine into the process chamber to remove a TiN layer attached to the process chamber.

7. The method of claim 6, wherein the second cleaning gas comprises at least one of a ClF₃ gas and a Cl₂ gas.

8. The method of claim 7, wherein the TiN layer attached to the process chamber reacts with the ClF₃ gas to be decomposed into TiF₄ gas, ClF gas, F₂ gas, and N₂ gas, which can be exhausted out of the process chamber.

9. The method of claim 6, wherein supplying the first cleaning gas is performed after repeating the forming of the TiAlN layer m times, and supplying the second cleaning gas is performed after repeating the supplying of the first cleaning gas n times, wherein n and m are integers.

10. The method of claim 1, wherein removing the TiAlN layer comprises supplying the TiCl₄ gas with a flow rate of between about 1 sccm to 10 slm for between about 10 seconds to 10 minutes.

11. The method of claim 10, wherein removing the TiAlN layer is performed in a temperature range from between about 400° C. to 550° C. and a pressure range from between about 0.1 torr to 100 torr.

12. A method for removing aTiAN layer from a process chamber, comprising:
supplying a first cleaning gas including TiCl₄ and ammonia (NH₃) gas into the process chamber;
reacting the TiAlN layer with the TiCl₄ gas and the ammonia (NH₃) gas to form AlCl₃ gas, hydrogen (H₂) gas, TiCl₄ gas, and hydrogen chloride (HCl) gas, and a TiN layer in a solid state; and
exhausting the AlCl₃ gas, the hydrogen (H₂) gas, the TiCl₄ gas, and the hydrogen chloride (HCl) gas out of the process chamber.

13. The method of claim 12, further comprising:
supplying a second cleaning gas containing chlorine into the process chamber;
reacting the TiN layer with the chlorine gas to form TiF₄ gas, ClF gas, F₂ gas, and N₂ gas; and
exhausting the TiF₄ gas, the ClF gas, the F₂ gas, and the N₂ gas out of the process chamber.

14. The method of claim 13, wherein the second cleaning gas is ClF₃ gas.

15. The method of claim 13, further comprising forming the TiAlN layer on a semiconductor wafer in the process chamber.

16. The method of claim 15, wherein supplying the first cleaning gas is performed after repeating the forming of the TiAlN layer m times, and supplying the second cleaning gas is performed after repeating the supplying of the first cleaning gas n times, wherein n and m are integers.

17. The method of claim 12, further comprising supplying the TiCl₄ gas with a flow rate of between about 1 sccm to 10 slm for between about 10 seconds to 10 minutes.

18. The method of claim 17, further comprising maintaining the process chamber in a temperature range from between about 400° C. to 550° C. and a pressure range from between about 0.1 torr to 100 torr while removing the TiAlN layer.
